(19) United States
(12) Patent Application Publication
(10) Pub. No.: US 2023/0074924 A1
(43) Pub. Date: Mar. 9, 2023

(54) HEAT EXCHANGER CORE

(71) Applicant: MITSUBISHI HEAVY INDUSTRIES, LTD., Tokyo (JP)

(72) Inventors: Koichi TANIMOTO, Tokyo (JP); Nobuhide HARA, Tokyo (JP); Hiroyuki NAKAHARAI, Tokyo (JP); Yoichi UEFUJI, Tokyo (JP); Takuo ODA, Tokyo (JP); Shunsaku EGUCHI, Tokyo (JP); Masaya HATANAKA, Tokyo (JP)

(73) Assignee: MITSUBISHI HEAVY INDUSTRIES, LTD., Tokyo (JP)

(21) Appl. No.: 17/801,144

(22) PCT Filed: Feb. 24, 2021
(86) PCT No.: PCT/JP2021/006860

§ 371 Date: Aug. 19, 2022

(30) Foreign Application Priority Data
Feb. 27, 2020 (JP) 2020-031581

(51) Int. Cl. F28D 9/00; F28F 3/04

(52) U.S. Cl. CPC F28D 9/0037; F28D 9/0062; F28F 3/04

(57) ABSTRACT

A heat exchanger core includes: a first passage; and a second passage extending along the first passage. At least one of the first passage or the second passage includes a plurality of narrowed portions in which an area of a passage cross section orthogonal to a passage extension direction is minimum, and a plurality of enlarged portions in which the area is maximum. The plurality of narrowed portions and the plurality of enlarged portions are alternately disposed in the passage extension direction.

### TECHNICAL FIELD

The present disclosure relates to a heat exchanger core.

The present application claims priority on Japanese Patent Application No, 2020-031581 filed on Feb. 27, 2020, the entire content of which is incorporated herein by reference.

### BACKGROUND

Patent Document 1 discloses a heat exchanger formed by laminating a layer where a plurality of first narrow passages through which a heated fluid flows are formed and a layer where a plurality of second narrow passages through which a heating fluid flows are formed.

### CITATION LIST

### Patent Literature

Patent Document 1: JP2019-007657A

### SUMMARY

### Technical Problem

However, in the heat exchanger (heat exchanger core) disclosed in Patent Document 1 described above, a heat transfer coefficient decreases on a downstream side of the passage due to growth of a temperature boundary film in the passage, which may make it difficult to efficiently perform heat exchange. In particular, in the case of a passage having a high aspect ratio (a passage whose length is much larger than a width (height)), the temperature boundary film spreads over a considerable portion of a passage cross section on the downstream side.

In view of the above, an object of at least one embodiment of the present disclosure is to provide a heat exchanger core capable of efficiently performing heat exchange.

### Solution to Problem

In order to achieve the above object, a heat exchanger core according to the present disclosure includes: a first passage; and a second passage extending along the first passage. At least one of the first passage or the second passage includes a plurality of narrowed portions in which an area of a passage cross section orthogonal to a passage extension direction is minimum, and a plurality of enlarged portions in which the area is maximum. The plurality of narrowed portions and the plurality of enlarged portions are alternately disposed in the passage extension direction.

### Advantageous Effects

With the heat exchanger core according to the present disclosure, since the plurality of narrowed portions and the plurality of enlarged portions are alternately disposed, development of the temperature boundary film is inhibited or the temperature boundary film is broken by the narrowed portions, making it possible to improve the heat transfer coefficient. Thus, with the heat exchanger core according to the present disclosure, it is possible to efficiently perform heat exchange.

### BRIEF DESCRIPTION OF DRAWINGS

FIG. 1 is a perspective view of a heat exchanger core according to Embodiment 1.

FIG. 2 is a cross-sectional view of the heat exchanger core shown in FIG. 1, taken along line II-II.

FIG. 3 is a cross-sectional view showing a first passage and a second passage according to an embodiment.

FIG. 4 is a cross-sectional view showing the first passage and the second passage according to an embodiment.

FIG. 5 is a cross-sectional view showing the first passage and the second passage according to an embodiment.

FIG. 6 is a perspective view showing the first passage and the second passage according to an embodiment.

FIG. 7 is a cross-sectional view showing the first passage and the second passage according to an embodiment.

FIG. 8 is a perspective view showing the first passage and the second passage according to an embodiment.

FIG. 9 is a cross-sectional view of the first passage and the second passage shown in FIG. 8, taken along line IX-IX.

FIG. 10 is a perspective view of a rib shown in FIG. 8.

FIG. 11 is a cross-sectional view of the rib shown in FIG. 10, taken along line XI-XI.

FIG. 12 is a cross-sectional view of the rib shown in FIG. 11, taken along line XII-XII.

### DETAILED DESCRIPTION

Hereinafter, a heat exchanger core according to the embodiments of the present disclosure will be described with reference to the drawings. The embodiments each indicate one aspect of the present disclosure, do not intend to limit the disclosure, and can optionally be modified within a range of a technical idea of the present disclosure.

[Schematic Configuration of Heat Exchanger Core]

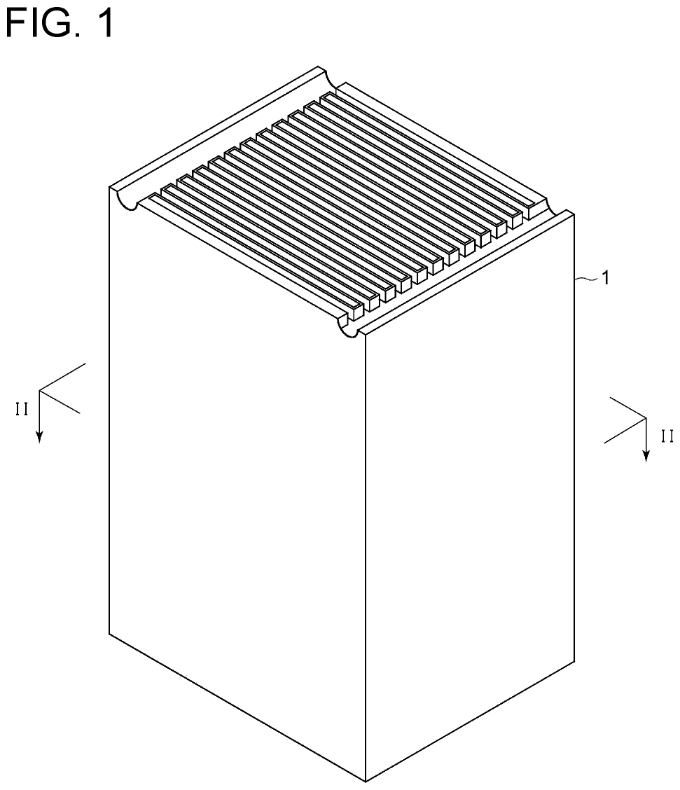

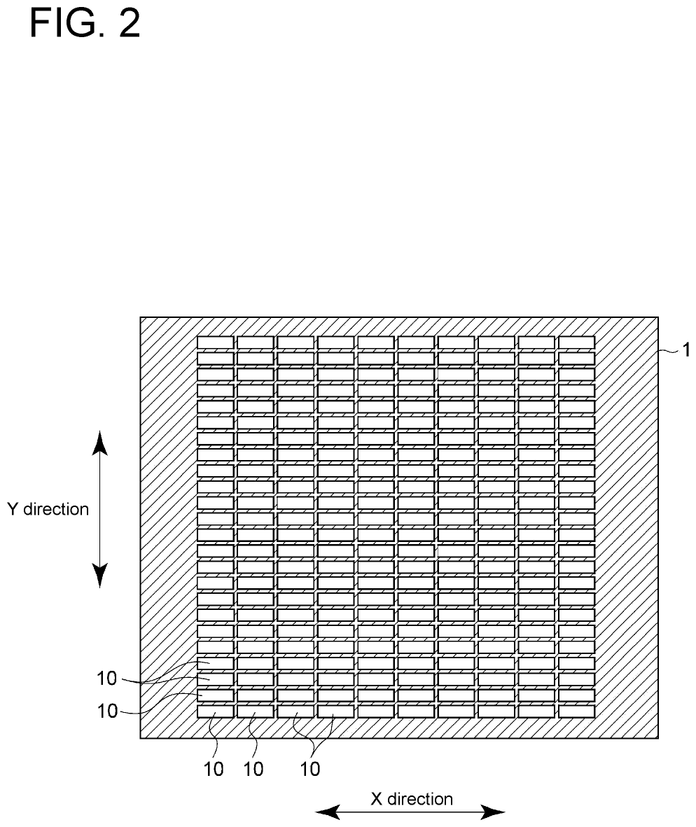

As shown in FIGS. 1 and 2, a heat exchanger core 1 according to the embodiment of the present disclosure is a main configuration of a heat exchanger in which heat exchange is performed between a high-temperature fluid and a low-temperature fluid, and is provided with passages 10 through which the high-temperature fluid and the low-temperature fluid flow, respectively. The high-temperature fluid and the low-temperature fluid may each be a liquid or a gas, but the temperatures of both are usually different. Further, although not limited, the heat exchanger core 1 can have a rectangular solid shape.

As shown in FIG. 2, the heat exchanger core 1 includes a first passage and a second passage extending along the first passage. As shown in FIGS. 1 and 2, in the heat exchanger core 1 having the rectangular solid shape, the plurality of passages 10 arranged in a lattice shape are disposed so as to extend along a longitudinal direction of the heat exchanger core 1, and these passages 10 constitute the first passage and the second passage. For example, if one of a pair of passages 10 and 10 adjacent to each other in a width direction (X direction in FIG. 2) of the heat exchanger core 1 constitutes the first passage, the other constitutes the second passage. Further, for example, if one of a pair of passages 10 and 10 adjacent to each other in a depth direction (Y direction in FIG. 2) of the heat exchanger core 1 constitutes the first passage, the other constitutes the second passage.

The plurality of passages 10 have a rectangular cross section in which the width direction of the heat exchanger core 1 is larger than the depth direction. Then, either the high-temperature fluid or the low-temperature fluid flows through the passages 10 adjacent to each oilier in the width direction of the heat exchanger core 1, and the high-temperature fluid and the low-temperature fluid flow alternately through the passages 10 adjacent to each other in the depth direction. Thus, the same fluid flows in the same direction in the passages 10 and 10 adjacent to each other in the width direction of the heat exchanger core 1, but in the passages 10 and 10 adjacent to each other in the depth direction, the high-temperature fluid and the low-temperature fluid flow may flow in the same direction (parallel flow) or may flow in the directions opposed to each other (opposed flow).

(Configuration of Passage)

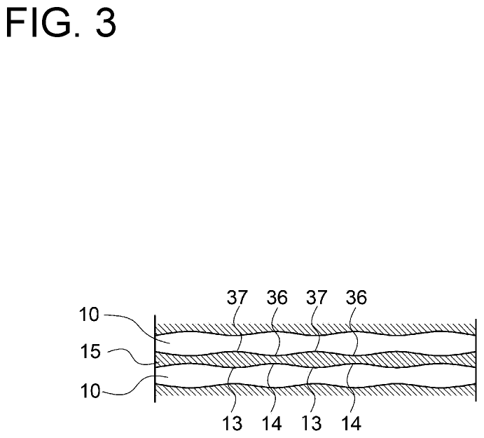

As shown in FIGS. 3 to 8, in the heat exchanger core 1 according to some embodiments, at least one of the first passage or the second passage includes a plurality of narrowed portions 13 in which an area of a passage cross section orthogonal to a passage extension direction is minimum, and a plurality of enlarged portions 14 in which the area of the passage cross section is maximum. Then, the plurality of narrowed portions 13 and the plurality of enlarged portions 14 are alternately disposed in the passage extension direction.

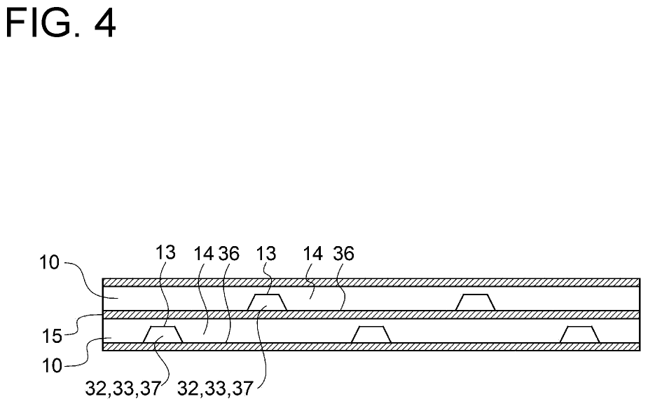

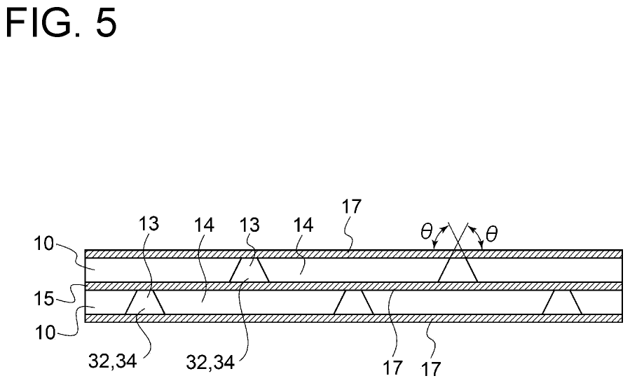

The plurality of narrowed portions 13 and the plurality of enlarged portions 14 may be formed by the passages 10 each having a variable passage width as shown in FIG. 3, or may be formed by protrusions 33 protruding to the passages 10 as shown in FIG. 4. Further, as shown in FIGS. 5 to 8, the plurality of narrowed portions 13 and the plurality of enlarged portions 14 may be formed by ribs 34 connecting opposed walls 17 and 17 of the passages 10.

With the heat exchanger core 1 according to some embodiments described above, since the plurality of narrowed portions 13 and the plurality of enlarged portions 14 are alternately disposed, development of a temperature boundary film is inhibited or the temperature boundary film is broken by the narrowed portions 13, making it possible to improve the heat transfer coefficient. Thus, the heat exchanger core 1 according to some embodiments can efficiently perform heat exchange.

As shown in FIGS. 3 to 8, the heat exchanger core 1 according to some embodiments is disposed between the first passage and the second passage, and includes a partition wall 15 for dividing the first passage 11 and the second passage. The narrowed portions 13 and the enlarged portions 14 described above each have a shape that changes the passage width orthogonal to the partition wall 15 in the passage extension direction.

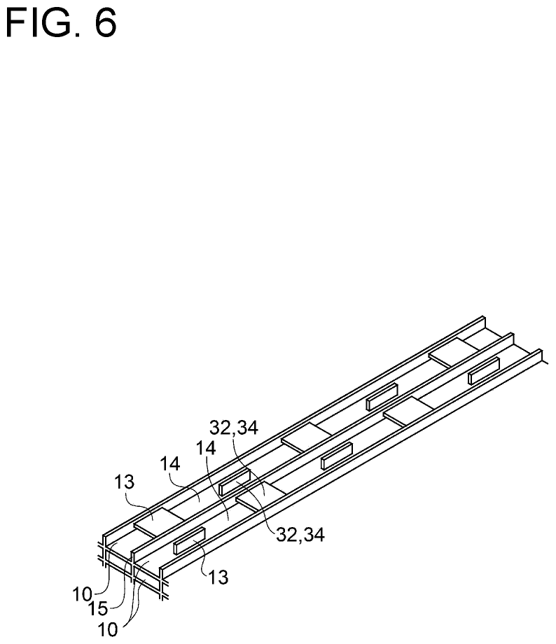

In the heat exchanger core 1 shown in FIGS. 4 to 8, one of the pair of passages 10 and 10 adjacent to each other in the depth direction of the heat exchanger core 1 constitutes the first passage, and the other constitutes the second passage. Then, the first passage and the second passage are divided by the partition wall 15 disposed between the first passage and the second passage. In the heat exchanger core 1 shown in FIG. 4, each protrusion 33 protruding to the passage 10 changes the passage width orthogonal to the passage 10, and in the heat exchanger core 1 shown in FIGS. 5 and 6, each rib 34 connecting the opposed walls 17 and 17 of the passage 10 changes the passage width orthogonal to the passage 10.

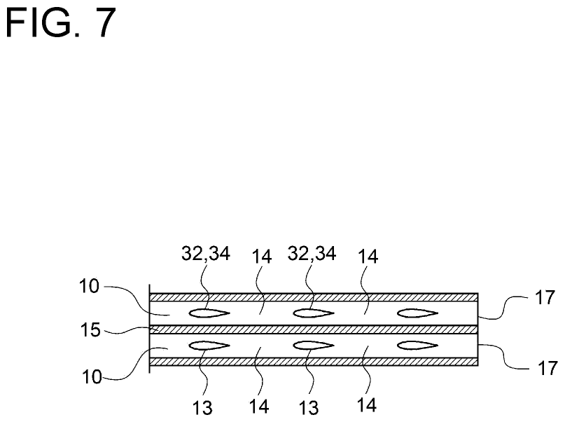

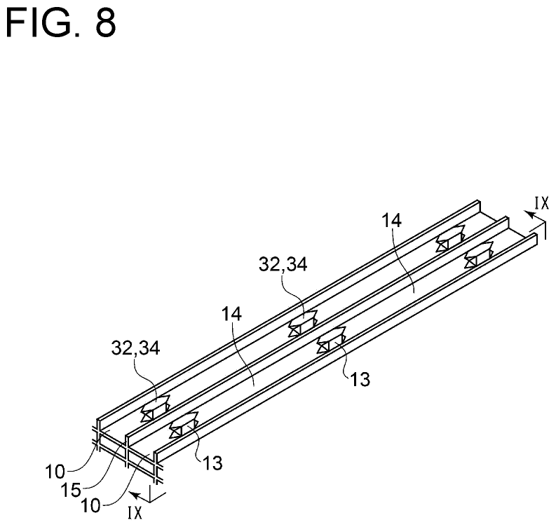

Further, in the heat exchanger core 1 shown in FIGS. 7 and 8, one of the pair of passages 10 and 10 adjacent to each other in the width direction of the heat exchanger core 1 constitutes the first passage, and the other constitutes the second passage. Then, the first passage and the second passage are divided by the partition wall 15 disposed between the first passage and the second passage. In the heat exchanger core 1 shown in FIGS. 7 and 8, each rib 34 connecting the opposed walls 17 and 17 of the passage changes the passage width orthogonal to the passage 10).

With the heat exchanger core 1 according to some embodiments described above, since the narrowed portions 13 and the enlarged portions 14 each have the shape that changes the passage width orthogonal to the partition wall 15 in the extension direction of the passage 10, it is possible to break the temperature boundary film in the vicinity of the partition wall that impairs heat exchange.

As shown in FIGS. 4 to 8, the heat exchanger core 1 according to some embodiments includes obstacles 32 disposed along the partition wall 15 at a plurality of positions in the passage extension direction, respectively, in at least one of the first passage or the second passage. Each obstacle 32 is disposed between the partition wall 15 and a passage wall 16 opposite to the partition wall 15, and at least one set of narrowed portions 13, 13 and enlarged portions 14, 14 are formed on both sides of the obstacle 32.

As long as the obstacles 32 are disposed along the partition wall 15 at the plurality of positions in the extension direction of the passage 10, respectively, in at least one of the first passage or the second passage, each of the Obstacles 32 includes an obstacle which is supported by a support column extending from the partition wall 15 and appears to float from the partition wall 15. Alternatively, each obstacle 32 may be the protrusion 33 protruding into the passage 10 as shown in FIG. 4, or the rib 34 connecting the opposed walls 17 and 17 of the passage 10 as shown in FIGS. 5 to 8. Thus, the obstacles 32 include various types of obstacles as long as the obstacles 32 are disposed at positions away from the partition wall in the center in the passage width direction.

With the heat exchanger core 1 according to some embodiments described above, it is possible to break the temperature boundary film on both sides of the obstacle 32.

As shown in FIG. 7, in the heat exchanger core 1 according to an embodiment, one of the pair of passages 10 adjacent to each other in the depth direction of the heat exchanger core 1 constitutes the first passage, and the other constitutes the second passage. Then, the first passage and the second passage are divided by the partition wall 15 disposed between the first passage and the second passage. The rib 34 is provided to connect the partition wall 15 and the passage wall 16 opposite to the partition wall 15. The cross section (longitudinal cross section) of the rib 34 in the passage extension direction has a line-symmetric streamline shape.

With the heat exchanger core 1 according to an embodiment described above, it is possible to break the temperature boundary film on both sides of the rib 34. Further, since the cross section of the rib 34 in the passage extension direction has the streamline shape, it is possible to suppress a passage resistance, and it is also possible to suppress generation of a stagnation region. Furthermore, since the entire surface of the streamlined rib 34 can be used as a heat transfer surface, it is possible to promote heat transfer.

As shown in FIGS. 3 and 4, in at least one of the first passage or the second passage of the heat exchanger core 1 according to some embodiments, the partition wall 15 includes recesses 36 and projections 37 as viewed in the passage extension direction.

In the heat exchanger core 1 shown in FIGS. 3 and 4, one of the pair of passages 10 and 10 adjacent to each other in the depth direction of the heat exchanger core 1 constitutes the first passage, and the other constitutes the second passage. Then, the first passage 11 and the second passage are divided by the partition wall 15 disposed between the first passage and the second passage. Then, in the heat exchanger core 1 shown in FIG. 3, the partition wall 15 includes the recesses 36 and the projections 37 as viewed in the passage extension direction. On the other hand, in the heat exchanger core 1 shown in FIG. 4, the protrusions 33 disposed on the partition wall 15 and protruding to the passage 10 form the recesses 36 and the projections 37.

With the heat exchanger core 1 according to some embodiments described above, since the partition wall 15 of at least one of the first passage or the second passage includes the recesses 36 and the projections 37 as viewed in the extension direction of the passage 10, it is possible to break the temperature boundary film in the vicinity of the partition wall that impairs heat exchange.

As shown in FIGS. 5, 6, and 8, in some embodiments, at least one of the first passage or the second passage includes the ribs 34 for connecting the opposed walls of the passages 10 along a minimum passage width passing through the centroid of the passage cross section. Then, each of the ribs 34 forms the narrowed portion 13 and the enlarged portion 14 described above.

Each rib 34 shown in FIG. 5 has a trapezoidal shape as viewed from a direction orthogonal to the passage extension direction, and a set of narrowed portions 13 and enlarged portions 14 are formed on both sides of the rib 34. Further, each rib 34 shown in FIG. 6 has a rectangular shape as viewed from the direction orthogonal to the passage extension direction, and a set of narrowed portions 13 and enlarged portions 14 are formed on the both sides of the rib 34.

With the heat exchanger core 1 according to the embodiments described above, not only the temperature boundary film can be broken, but also the passage structure can be reinforced by the ribs 34. For example, it is possible to prevent damage due to a differential pressure of the passage partition wall, a thermal stress acting on the heat exchanger core 1, or the like.

As shown in FIG. 5, in the heat exchanger core 1 according to an embodiment, each rib 34 has inclined surfaces whose angle θ with respect to the passage extension direction is not greater than 60 degrees, preferably not greater than 45 degrees. Each rib 34 shown in FIG. 5 has, on the both sides in the passage extension direction, the inclined surfaces whose angle θ with respect to the passage extension direction is not greater than 60 degrees, preferably not greater than 45 degrees. Thus, each rib 34 shown in FIG. 5 has the trapezoidal shape as viewed from the direction orthogonal to the passage extension direction.

With the heat exchanger core 1 according to the embodiments described above, since each rib 34 has the inclined surfaces whose angle θ with respect to the passage extension direction is 60 degrees, preferably not greater than 45 degrees, even if the heat exchanger core 1 is modeled by additive manufacturing with priority given to the passage extension direction, it is possible to perform additive manufacturing on the heat exchanger core 1 including the rib 34 as well while avoiding a problem of, for example, occurrence of a modeling failure due to a loss of an overhang shape having a downward surface with respect to a lamination direction, or occurrence of warpage of the modeled product due to a residual stress caused during modeling and resultant deterioration in accuracy (hereinafter, referred to as “overhang problem”).

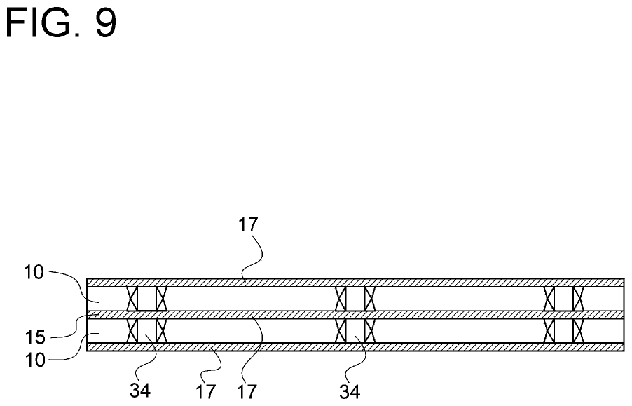

As shown in FIGS. 8 and 9, in the heat exchanger core 1 according to an embodiment, each rib 34 has a cross-sectional shape along the extension direction of the rib 34, where the length of the rib 34 in the extension direction of the passage 10 decreases as a distance from the opposed wall 17, 17 increases.

With the heat exchanger core 1 according to the embodiments described above, it is possible to reduce the passage resistance relative to the rib having the cross-sectional shape along the extension direction of the rib where the rib length in the passage extension direction is constant, and it is possible to decrease a pressure loss.

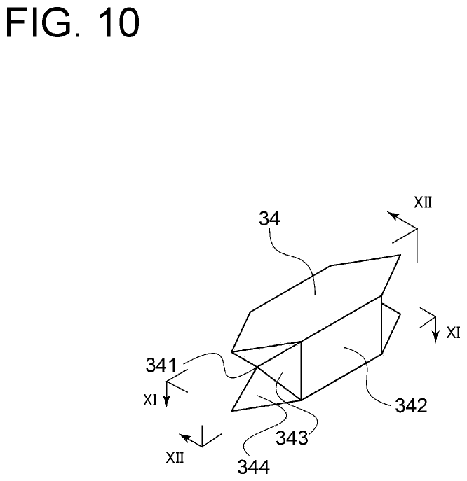

As shown in FIG. 10, in the heat exchanger core 1 according to an embodiment, the rib 34 includes a constricted portion 341 located between the opposed walls 17 and 17, and having the minimum length of the rib 34 in the extension direction of the passage 10.

With the heat exchanger core 1 according to the embodiment described above, since the passage resistance is reduced toward the constricted portion 341, it is possible to decrease the pressure loss in the rib 34 relative to a rib without a constricted portion.

As shown in FIG. 11, in the heat exchanger core 1 according to an embodiment, the cross section of the rib 34 along the opposed walls in the constricted portion 341 is tapered toward ends of the rib 34 in the passage extension direction.

With the heat exchanger core 1 according to an embodiment described above, it is possible to stabilize the flow of the fluid flowing through the passage 10 and branching at the ends of the rib 34 in the passage extension direction.

As shown in FIG. 11, in the heat exchanger core 1 according to an embodiment, the rib 34 is tapered toward the ends of the rib 34 in the passage extension direction in the opposed walls 17, 17 and the constricted portion 341, and the ends of the rib 34 in the passage extension direction are sharp in the opposed walls 17, 17 and the constricted portion 341. However, the ends of the rib 34 in the passage extension direction may be rounded at least in the opposed walls 17, 17.

With the heat exchanger core 1 according to the embodiment described above, since the ends of the rib 34 in the passage extension direction are rounded at least in the opposed walls 17, 17, it is possible to reduce the pressure loss of the fluid flowing through the passage 10.

As shown in FIG. 10, in the heat exchanger core 1 according to an embodiment, the rib 34 includes a pair of side walls 342, 342, a pair of first tapered surfaces 343, 343, and a pair of second tapered surfaces 344, 344. The pair of side walls 342, 342 connect the opposed walls 17 and 17 along the extension direction of the passage 10 and a plane including orthogonal direction of the opposed walls. The pair of first tapered surfaces 343, 343 are connected to the pair of side walls 342, 342 at the ends of the rib 34 in the extension direction of the passage 10, respectively, and define the tapered shape of the rib 34. The pair of second tapered surfaces 344, 344 are respectively connected to the pair of first tapered surfaces 343, 343, and protrude from the first tapered surfaces 343 in the extension direction of the passage 10 and the direction orthogonal to the extension direction of the passage 10.

In the heat exchanger core 1 according to an embodiment described above, the fluid flowing through the passage 10 is branched by a ridge line separating the pair of second tapered surfaces 344, 344 by the time the fluid reaches the constricted portion 341. Then, the branched fluid flows along the second tapered surfaces 344, the first tapered surfaces 343, and the side walls 342 in the order of the second tapered surfaces 344, the first tapered surfaces 343, and the side walls 342.

With the heat exchanger core 1 according to the embodiment described above, since the fluid flowing through the passage 10 is branched by the ridge line separating the second tapered surfaces by the time the fluid reaches the constricted portion 341, it is possible to stabilize the flow of the fluid to be branched. Further, since the branched fluid flows along the second tapered surfaces 344, the first tapered surfaces 343, and the side walls 342 in the order of the second tapered surfaces 344, the first tapered surfaces 343, and the side walls 342, it is possible to stabilize the flow of the branched fluid as well.

Further, as shown in FIG. 10, in the heat exchanger core 1 according to an embodiment, the first tapered surfaces 343 and the second tapered surfaces 344 are each formed by a flat surface.

With the heat exchanger core 1 according to the embodiment described above, since the boundary between the first tapered surface 343 and the second tapered surface 344 is separated by the ridge line, the boundary between the first tapered surface 343 and the second tapered surface 344 is clear, and it is possible to stabilize the flow of the fluid. Further, since the first tapered surfaces 343 and the second tapered surfaces 344 each have the flat surface, it is possible to reduce manufacturing data in the case of modeling the heat exchanger core 1 by additive manufacturing as compared with a case where the first tapered surfaces 343 and the second tapered surfaces 344 each have the streamline shape (curved surface). Thus, the heat exchanger core 1 is easily modeled, and it is also possible to reduce the manufacturing cost.

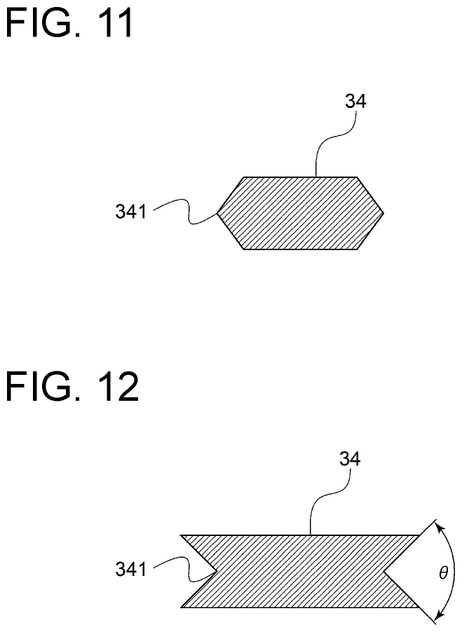

Further, as shown in FIG. 12, in the heat exchanger core 1 according to an embodiment, in the cross section of the rib 34 along the opposed wall 17, the tip angle θ of the rib 34 formed between the pair of second tapered surfaces 343 and 343 is not greater than 120 degrees, preferably not greater than 90 degrees.

With the heat exchanger core 1 according to the embodiment described above, in the cross section of the rib 34 along the opposed wall 17, since the tip angle θ of the rib 34 formed between the pair of second tapered surfaces 343 and 343 is not greater than 120 degrees, even if the opposed wall 17 is preferentially modeled in the case where the heat exchanger core 1 is modeled by additive manufacturing, it is possible to perform additive manufacturing on the heat exchanger core 1 including the rib 34 while avoiding the overhang problem.

Further, as shown in FIG. 10, in the heat exchanger core 1 according to an embodiment, the first tapered surfaces 343, 343 extend along the plane including the orthogonal direction of the opposed walls 17, 17.

With the heat exchanger core 1 according to the embodiment described above, since the fluid flowing through the passage 10 flows evenly with respect to the opposed walls 17, 17, it is possible to stabilize the flow of the fluid.

The present invention is not limited to the above-described embodiments, and also includes an embodiment obtained by modifying the above-described embodiments and an embodiment obtained by combining these embodiments as appropriate.

The contents described in the above embodiments would be understood as follows, for instance.

(1) A heat exchanger core 1 according to one aspect includes: a first passage; and a second passage extending along the first passage. At least one of the first passage or the second passage includes a plurality of narrowed portions 13 in which an area of a passage cross section orthogonal to a passage extension direction is minimum, and a plurality of enlarged portions 14 in which the area is maximum. The plurality of narrowed portions 13 and the plurality of enlarged portions 14 are alternately disposed in the passage extension direction.

With the heat exchanger core 1 according to the present disclosure, since the plurality of narrowed portions 13 and the plurality of enlarged portions 14 are alternately disposed, development of the temperature boundary film is inhibited or the temperature boundary film is broken by the narrowed portions 13, making it possible to improve the heat transfer coefficient. Thus, the heat exchanger core 1 according to the present disclosure can efficiently perform heat exchange.

(2) The heat exchanger core 1 according to another aspect is the heat exchanger core 1 as defined in (1), which includes: a partition wall 15 disposed between the first passage and the second passage to divide the first passage and the second passage. The narrowed portions 13 and the enlarged portions 14 each have a shape that changes a passage width orthogonal to the partition wall 15 in the passage extension direction.

With such configuration, since the narrowed portions 13 and the enlarged portions 14 each have the shape that changes the passage width orthogonal to the partition wall 15 in the passage extension direction, it is possible to break the temperature boundary film in the vicinity of the partition wall that impairs heat exchange.

(3) The heat exchanger core 1 according to still another aspect is the heat exchanger core 1 as defined in (2), which includes: obstacles 32 disposed along the partition wall at a plurality of positions in the passage extension direction, respectively, in at least one of the first passage or the second passage. Each of the obstacles 32 is disposed between the partition wall 15 and a passage wall opposite to the partition wall 15, and at least one set of the narrowed portions 13 and the enlarged portions 14 are formed on both sides of the obstacle 32.

With such configuration, it is possible to break the temperature boundary film on the both sides of the obstacle 32.

(4) The heat exchanger core 1 according to yet another aspect is the heat exchanger core 1 as defined in (2), where the partition wall 15 of at least one of the first passage or the second passage includes a recess 36 and a projection 37 as viewed in the passage extension direction.

With such configuration, since the partition wall 15 of at least one of the first passage or the second passage includes the recess 36 and the projection 37 as viewed in the passage extension direction, it is possible to break the temperature boundary film in the vicinity of the partition wall 15 that impairs heat exchange.

(5) The heat exchanger core 1 according to yet another aspect is the heat exchanger core 1 as defined in any one of (1) to (3), where at least one of the first passage or the second passage includes a rib 34 for connecting opposed walls 17, 17 of the passage along a direction along a minimum passage width passing through a centroid of the passage cross section, and the rib 34 forms the narrowed portions 13 and the enlarged portions 14.

With such configuration, not only the temperature boundary film can be broken, but also the passage structure can be reinforced by the rib 34. For example, it is possible to prevent damage due to a differential pressure of the partition wall 15, a thermal stress acting on the heat exchanger core 1, or the like.

(6) The heat exchanger core 1 according to yet another aspect is the heat exchanger core as defined in (5), where the rib has an inclined surface whose angle θ with respect to the passage extension direction is not greater than 60 degrees.

With such configuration, since the rib has the inclined surface whose angle θ with respect to the passage extension direction is not greater than 60 degrees, even if the heat exchanger core 1 is modeled by additive manufacturing with priority given to the passage extension direction, it is possible to perform additive manufacturing on the heat exchanger core 1 including the rib 34 as well while avoiding the overhang problem.

(7) The heat exchanger core 1 according to yet another aspect is the heat exchanger core 1 as defined in (5), where the rib 34 has a cross-sectional shape along an extension direction of the rib 34, where a length of the rib 34 in the passage extension direction decreases as a distance from the opposed walls 17, 17 increases.

With such configuration, it is possible to reduce the passage resistance relative to the rib having the cross-sectional shape along the extension direction of the rib where the rib length in the passage extension direction is constant, and it is possible to decrease a pressure loss.

(8) The heat exchanger core 1 according to yet another aspect is the heat exchanger core 1 as defined in (5) or (7), where the rib 34 includes a constricted portion 341 located between the opposed walls 17, 17 and having a minimum length of the rib 34.

With such configuration, since the passage resistance is reduced toward the constricted portion 341, it is possible to decrease the pressure loss in the rib 34 relative to a rib without a constricted portion.

(9) The heat exchanger core 1 according to yet another aspect is the heat exchanger core 1 as defined in (8), where the rib 34 has a cross section along the opposed walls in the constricted portion 341, the cross section being tapered toward an end of the rib 34.

With such configuration, it is possible to stabilize the flow of the fluid flowing through the passage 10 and branching at the end of the rib 34.

(10) The heat exchanger core 1 according to yet another aspect is the heat exchanger core as defined in (8) or (9), where the rib has rounded ends at least in the opposed walls.

With such configuration, it is possible to reduce the pressure loss of the fluid flowing through the passage 10.

(11) The heat exchanger core 1 according to yet another aspect is the heat exchanger core 1 as defined in any one of (5) to (10), where the rib 34 includes: a pair of side walls 342, 342 connecting the opposed walls 17, 17 along the passage extension direction and a plane including an orthogonal direction of the opposed walls 17, 17; a pair of first tapered surfaces 343, 343 connected to the pair of side walls 342, 342 at ends of the rib 34 in the passage extension direction, respectively, and defining a tapered shape of the rib 34; and a pair of second tapered surfaces 344, 344 respectively connected to the pair of first tapered surfaces 343, 343, and protruding from the first tapered surfaces 343, 343 in the passage extension direction and a direction orthogonal to the passage extension direction.

With such configuration, since the fluid flowing through the passage 10 is branched by the ridge line separating the pair of second tapered surfaces 344, 344 by the time the fluid reaches the constricted portion 341, it is possible to stabilize the flow of the fluid to be branched. Further, since the branched fluid flows along the second tapered surfaces 344, the first tapered surfaces 343, and the side walls 342 in the order of the second tapered surfaces 344, the first tapered surfaces 343, and the side walls 342, it is possible to stabilize the flow of the branched fluid as well.

(12) The heat exchanger core 1 according to yet another aspect is the heat exchanger core 1 as defined in (11), where the first tapered surfaces 343, 343 and the second tapered surfaces 344, 344 are each formed by a flat surface.

With such configuration, since the boundary between the first tapered surface 343 and the second tapered surface 344 is separated by the ridge line, the boundary between the first tapered surface 343 and the second tapered surface 344 is clear, and it is possible to stabilize the flow of the fluid. Further, with the first tapered surfaces 343 and the second tapered surfaces, it is possible to reduce manufacturing data in the case of modeling the heat exchanger core 1 by additive manufacturing as compared with the case where the first tapered surfaces 343 and the second tapered surfaces each have the streamline shape (curved surface). Thus, the heat exchanger core 1 is easily modeled, and it is also possible to reduce the manufacturing cost.

(13) The heat exchanger core 1 according to yet another aspect is the heat exchanger core 1 as defined in (11) or (1.2), where, in a cross section of the rib 34 along the opposed walls, a tip angle θ of the rib formed between the pair of second tapered surfaces 344, 344 is not greater than 120 degrees.

With such configuration, in the cross section of the rib 34 along the opposed wall 17, since the tip angle θ of the rib 34 formed between the pair of second tapered surfaces 343 and 343 is not greater than 120 degrees, even if the opposed wall 17 is preferentially modeled in the case where the heat exchanger core 1 is modeled by additive manufacturing, it is possible to perform additive manufacturing on the heat exchanger core 1 including the rib 34 while avoiding the overhang problem.

(14) The heat exchanger core 1 according to yet another aspect is the heat exchanger core 1 as defined in any one of (11) to (13), where the first tapered surfaces 343 extend along the plane including the orthogonal direction of the opposed walls.

With such configuration, since the fluid flowing through the passage 10 flows evenly with respect to the opposed walls 17, 17, it is possible to stabilize the flow of the fluid.

### REFERENCE SIGNS LIST

Heat exchanger core
10 Passage
13 Narrowed portion
14 Enlarged portion
15 Partition wall
16 Passage wall
17 Opposed wall
32 Obstacle
33 Protrusion
34 Rib
341 Constricted portion
342 Side wall
343 First tapered surface
344 Second tapered surface
36 Recess
37 Protrusion

1. A heat exchanger core, comprising
a first passage; and
a second passage extending along the first passage,
wherein at least one of the first passage or the second passage includes a plurality of narrowed portions in which an area of a passage cross section orthogonal to a passage extension direction is minimum, and a plurality of enlarged portions in which the area is maximum, and
wherein the plurality of narrowed portions and the plurality of enlarged portions are alternately disposed in the passage extension direction.

2. The heat exchanger core according to claim 1, comprising:
a partition wall disposed between the first passage and the second passage to divide the first passage and the second passage,
wherein the narrowed portions and the enlarged portions each have a shape that changes a passage width orthogonal to the partition wall in the passage extension direction.

3. The heat exchanger core according to claim 2, comprising:
obstacles disposed along the partition wall at a plurality of positions in the passage extension direction, respectively, in at least one of the first passage or the second passage, and
wherein each of the obstacles is disposed between the partition wall and a passage wall opposite to the partition wall, and at least one set of the narrowed portions and the enlarged portions are formed on both sides of the obstacle.

4. The heat exchanger core according to claim 2,
wherein the partition wall of at least one of the first passage or the second passage includes a recess and a projection as viewed in the passage extension direction.

5. The heat exchanger core according to claim 1,
wherein at least one of the first passage or the second passage includes a rib for connecting opposed walls of the passage along a direction along a minimum passage width passing through a centroid of the passage cross section, and
wherein the rib forms the narrowed portions and the enlarged portions.

6. The heat exchanger core according to claim 5,
wherein the rib has an inclined surface whose angle with respect to the passage extension direction is not greater than 60 degrees.

7. The heat exchanger core according to claim 5,
wherein the rib has a cross-sectional shape along an extension direction of the rib, where a length of the rib in the passage extension direction decreases as a distance from the opposed walls increases.

8. The heat exchanger core according to claim 5,
wherein the rib includes a constricted portion located between the opposed walls and having a minimum length of the rib.

9. The heat exchanger core according to claim 8,
wherein the rib has a cross section along the opposed walls in the constricted portion, the cross section being tapered toward an end of the rib.

10. The heat exchanger core according to claim 8,
wherein the rib has rounded ends at least in the opposed walls.

11. The heat exchanger core according to claim 5,
wherein the rib includes:
a pair of side walls connecting the opposed walls along the passage extension direction and a plane including an orthogonal direction of the opposed walls;
a pair of first tapered surfaces connected to the pair of side walls at ends of the rib in the passage extension direction, respectively, and defining a tapered shape of the rib; and
a pair of second tapered surfaces respectively connected to the pair of first tapered surfaces, and protruding from the first tapered surfaces in the passage extension direction and a direction orthogonal to the passage extension direction.

12. The heat exchanger core according to claim 11,
wherein the first tapered surfaces and the second tapered surfaces are each formed by a flat surface.

13. The heat exchanger core according to claim 11,
wherein, in a cross section of the rib along the opposed walls, a tip angle of the rib formed between the pair of second tapered surfaces is not greater than 120 degrees.

14. The heat exchanger core according to claim 11,
wherein the first tapered surfaces extend along the plane including the orthogonal direction of the opposed walls.
